(19) United States
(12) Patent Application Publication
(10) Pub. No.: US 2011/0287943 A1
(43) Pub. Date: Nov. 24, 2011

(54) BASE FOR SUPERCONDUCTING WIRE AND SUPERCONDUCTING WIRE

(75) Inventor: Hiroyuki FUKUSHIMA, Tokyo (JP)

(73) Assignee: FURUKAWA ELECTRIC CO., LTD., Tokyo (JP)

(21) Appl. No.: 13/110,124

(22) Filed: May 18, 2011

(30) Foreign Application Priority Data
May 21, 2010 (JP) 2010-117077

(51) Int. Cl. H01B 12/02; B32B 5/00; B32B 15/04; H01B 12/00

(52) U.S. Cl. 505/230; 505/239; 428/448; 428/336; 174/125.1

(57) ABSTRACT

A base for a superconducting wire, the base includes: a metal substrate; a bed layer constituted of nesosilicate and formed on the metal substrate; and an oriented layer formed on the bed layer.

### BACKGROUND OF THE INVENTION

1. Field of the Invention

The present invention relates to a base for a superconducting wire and to a superconducting wire which are used for a superconducting device such as a superconducting cable and a superconducting magnet, and, in particular, relates to an intermediate layer formed on a metal substrate of the base.

2. Description of the Related Art

Conventionally, an RE-based superconductor (RE stands for rare earth) is known as a type of a high temperature superconductor which shows superconductivity at a liquid-nitrogen temperature (77 K) or more. In particular, an yttrium-based superconductor expressed by a chemical formula of YBa₂Cu₃O_{7-y} (a Y-based superconductor or YBCO, hereinbelow) is a representative thereof.

In general, a superconducting wire using a Y-based superconductor (a Y-based superconducting wire, hereinbelow) has a laminated structure in which an intermediate layer, a layer constituted of a Y-based superconductor (a Y-based superconducting layer, hereinbelow), and a stabilizing layer are formed on a tape-shaped metal substrate in the order named. Such a Y-based superconducting wire is manufactured, for example, by depositing a biaxially oriented intermediate layer on a low-magnetic non-oriented metal (Hastelloy, for example) substrate, and depositing a Y-based superconducting layer on the intermediate layer by pulsed laser deposition (PLD), metal organic chemical vapor deposition (MOCVD), or the like. In the following, a long base constituted of a metal substrate and an intermediate layer is referred to as a base for a superconducting wire.

It is known that electrical conductivity of such a superconducting wire largely depends on a crystal orientation of a superconductor thereof, and in particular a biaxial orientation of the superconductor. Therefore, it is necessary to improve crystallinity of an intermediate layer which serves as a bed for a superconducting layer constituted of the superconductor, whereby a superconducting layer having a high biaxial orientation is obtained. As a method therefor, for example, Japanese Patent Application Laid-open Publication No. hei 4-331795 and Japanese Patent Application Laid-open Publication No. 2007-73327 disclose ion beam assisted deposition (IBAD). IBAD is a method for depositing an oriented layer by applying an assisting ion beam to a deposition surface from an oblique direction while accumulating particles evaporated from an evaporation source on the deposition surface. In IBAD, rock-salt MgO is used as the evaporation source since a thin film having a high biaxial orientation can be obtained thereby, and this is the mainstream in the development of the intermediate layer. In the following, an MgO layer deposited by IBAD is referred to as an IBAD-MgO layer.

In order to achieve a high biaxial orientation in the IBAD-MgO layer, it is necessary for its bed to have smoothness and low reactivity with MgO. Therefore, immediately under the IBAD-MgO layer, a bed layer is formed, the bed layer which is constituted of a substance, such as yttrium oxide (Y₂O₃) or GZO (Gd₂Zr₂O₇), which can be amorphously deposited so as to facilitate orientation of IBAD-MgO.

Furthermore, in order to obtain high electrical conductivity in the superconducting wire, it is necessary to prevent cations (Ni, Mo, or Mn, for example) of the metal substrate from diffusing into the superconducting layer. Therefore, in general, a barrier layer (a diffusion preventing layer) is situated between the bed layer and the metal substrate, the barrier layer which is constituted of aluminium oxide (Al₂O₃), GZO, YSZ (yttrium-stabilized zirconia), chromium oxide (Cr₂O₃), or the like.

In addition, in order to protect the IBAD-MgO layer which easily reacts with the air, and also to increase lattice matching with the superconducting layer (YBCO, for example), a cap layer constituted of CeO₂ or the like is formed on the IBAD-MgO layer.

As described above, GZO can facilitate the orientation of IBAD-MgO, and also functions as the barrier layer. Therefore, GZO is favorable as a constituent material of the bed layer. Japanese Patent Application Laid-open Publication No. 2010-86666 discloses a base for a superconducting wire, the base which has a laminated structure of a CeO₂ cap layer, an IBAD-MgO oriented layer, a GZO bed layer, and a metal substrate.

### SUMMARY OF THE INVENTION

However, there is a case where the GZO bed layer is crystallized by heat treatment by which a substrate surface layer is formed. In the case, the function of the GZO bed layer to facilitate the orientation of the IBAD-MgO layer is impaired, and hence the orientation degree of the IBAD-MgO layer decreases (the IBAD-MgO layer is oriented more easily when its bed is amorphous). When the orientation degree of the IBAD-MgO layer decreases, high electrical conductivity cannot be obtained in the superconducting wire. With regard to that, there is an experimentation result that the orientation degree Δφ was 6° when the IBED-MgO layer was formed on the GZO bed layer without the heat treatment, and the orientation degree Δφ decreased to 7° when the IBED-MgO layer was formed on the GZO bed layer after the heat treatment, for example.

The present invention is made in order to solve the problems described above, and an object of the present invention is to provide a technology by which electrical conductivity of a superconducting wire is improved.

A first aspect of the present invention is a base for a superconducting wire, the base including: a metal substrate; a bed layer constituted of nesosilicate and formed on the metal substrate; and an oriented layer formed on the bed layer.

A second aspect of the present invention is a superconducting wire including: the base; and a superconducting layer formed on a surface of the base.

### BRIEF DESCRIPTION OF THE DRAWINGS

FIG. 1 shows a laminated structure of a superconducting wire according to an embodiment of the present invention;

FIG. 2 shows a structure of a base for a superconducting wire according to the embodiment of the present invention; and

FIG. 3 shows a manufacturing process of the base according to the embodiment of the present invention.

### DESCRIPTION OF THE PREFERRED EMBODIMENT

In the following, an embodiment of the present invention is described in detail.

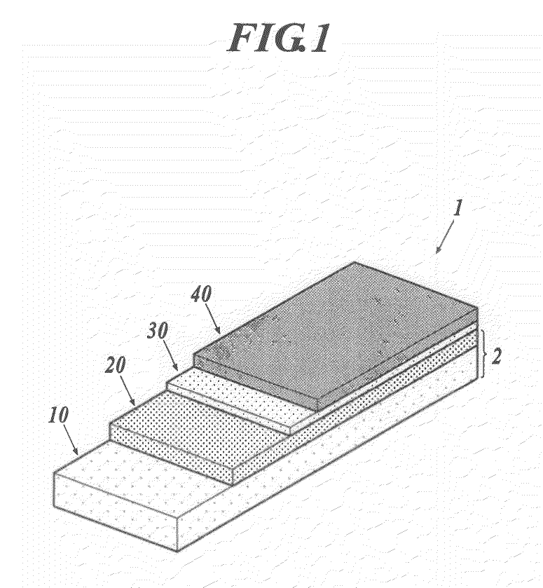

FIG. 1 shows a laminated structure of a superconducting wire 1 according to an embodiment of the present invention.

As shown in FIG. 1, the Y-based superconducting wire 1 has a laminated structure in which an intermediate layer 20, a superconducting layer 30, and a stabilizing layer 40 are formed on a tape-shaped metal substrate 10 in the order named. The tape-shaped metal substrate 10 and the intermediate layer 20 shown in FIG. 1 constitute a base for a superconducting wire (a base 2) according to the embodiment of the present invention.

In the embodiment, the metal substrate 10 is a low magnetic non-oriented metal (Hastelloy, for example) substrate. The intermediate layer 20 includes a bed layer and an oriented layer. The intermediate layer 20 is formed to achieve a high biaxial orientation in the superconducting layer 30. The superconducting layer 30 is a Y-based superconducting layer constituted of a Y-based superconductor, and deposited, for example, by MOCVD. On the upper surface of the superconducting layer 30, the stabilizing layer 40 constituted of argent is deposited, for example, by sputtering.

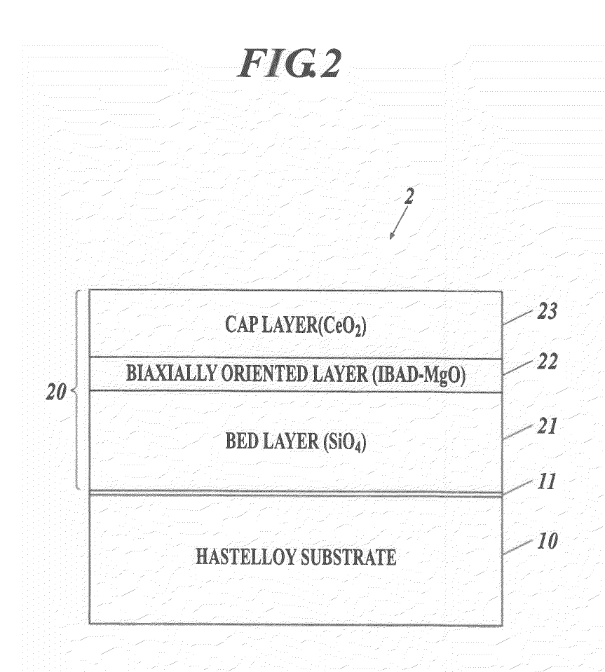

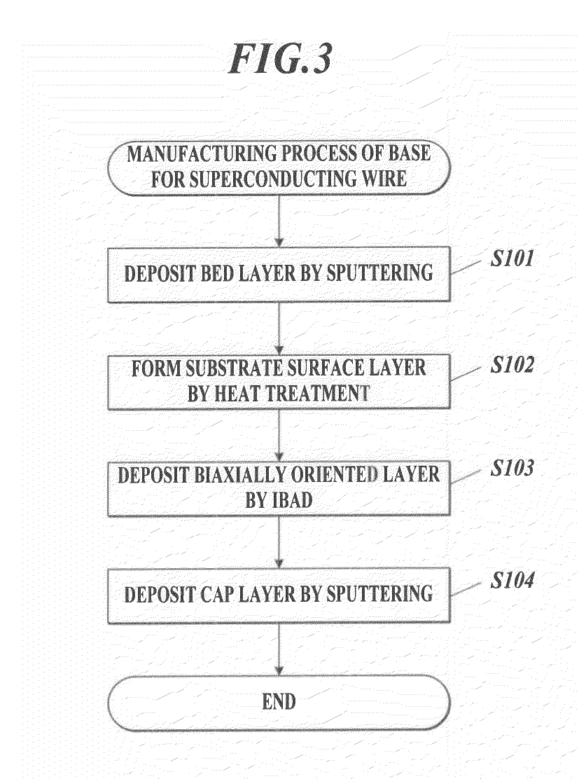

FIG. 2 shows a structure of the base 2 according to the embodiment of the present invention, and FIG. 3 shows a manufacturing process of the base 2.

As shown in FIG. 2, the intermediate layer 20 includes a bed layer 21, an oriented layer 22, and a cap layer 23.

The bed layer 21 facilitates the orientation of the oriented layer 22, and also prevents constituent elements of the metal substrate 10 from diffusing. The thickness of the bed layer 21 is 10 nm to 500 nm. In the embodiment, the bed layer is constituted of nesosilicate which has high oxygen permeability. For example, while the filling factor of GZO is 0.68, the filling factor of ZrSiO₄ which is nesosilicate is 0.63. That is, ZrSiO₄ is more permeable to oxygen.

The bed layer 21 is deposited, for example, by radio frequency (RF) sputtering (Step S101 in FIG. 3). The deposition condition thereof is set in accordance with the thickness of the bed layer 21 to be deposited and the like. For example, the deposition condition thereof is that the RF sputtering power is 100 W to 500 W, the wire traveling speed is 10 m/h to 100 m/h, and the deposition temperature is 20° C. to 500° C.

The oriented layer 22 is a polycrystalline thin film constituted of MgO with which a crystal of the superconducting layer 30 is oriented in a certain direction. The thickness of the oriented layer 22 is 3.0 nm to 10 nm. The oriented layer 22 is deposited by IBAD by which an assisting ion beam is applied to a deposition surface from an oblique direction while particles evaporated from an evaporation source (MgO) are accumulated on the deposition surface (Step S103 in FIG. 3). The deposition condition thereof is set in accordance with the thickness of the oriented layer 22 to be deposited and the like. For example, the deposition condition thereof is that the assisting ion beam voltage is 800 V to 1500 V, the assisting ion beam current is 80 mA to 350 mA, the assisting ion beam acceleration voltage is 200 V, the RF sputtering power is 800 W to 1500 W, the wire traveling speed is 80 m/h to 500 m/h, and the deposition temperature is 100° C. to 300° C.

The cap layer 23 protects the oriented layer 22, and also increases lattice matching with the superconducting layer 30. The thickness of the cap layer 23 is 10 nm to 500 nm. The cap layer 23 is deposited, for example, by sputtering (Step S104 in FIG. 3). The deposition condition thereof is set in accordance with the thickness of the cap layer 23 to be deposited and the like. For example, the deposition condition thereof is that the RF sputtering power is 100 W to 1000 W, the wire traveling speed is 5 m/h to 50 m/h, and the deposition temperature is 500° C. to 600° C.

In the base 2, a substrate surface layer 11 constituted of an oxide (Cr₂O₃, for example) of a constituent element of the metal substrate 10 is formed on an interface between the metal substrate 10 and the bed layer 21. The substrate surface layer 11 is formed to prevent the intermediate layer 20 from detaching in depositing the superconducting layer 30.

The substrate surface layer 11 is formed by carrying out predetermined heat treatment over the whole length of the base 2 after the bed layer 21 is formed on the metal substrate 10 (Step S102 in FIG. 3). The heat treatment condition is set in accordance with the thickness of the bed layer 21, the thickness of the substrate surface layer 11 to be formed, and the like. For example, in a case where the thickness of the bed layer 21 is 100 nm, and the thickness of the substrate surface layer 11 to be formed is 50 nm, the heat treatment condition is that the temperature is 500° C., and the treating time is half an hour (the wire traveling speed is 1.5 m/h).

As described above, the base 2 according to the embodiment includes the metal substrate 10, the bed layer 21 constituted of nesosilicate and formed on the metal substrate 10, and the oriented layer 22 formed on the bed layer 21 by IBAD. In addition, by the predetermined heat treatment after the bed layer 21 is formed, the substrate surface layer 11 constituted of an oxide of a constituent element of the metal substrate 10 is formed on the interface between the metal substrate 10 and the bed layer 21.

Since nesosilicate remains amorphous even at a high temperature of 500° C., the bed layer 21 is not easily crystallized by the heat treatment by which the substrate surface layer 11 is formed. Even when the bed layer 21 is crystallized by the heat treatment, it is known that nesosilicate undergoes a transition to an amorphous phase by applying an ion beam.

On the other hand, it has been confirmed that, in a case of the bed layer 21 constituted of GZO, the bed layer 21 is partly crystallized by the heat treatment by which the substrate surface layer 11 is formed. It has also been confirmed that, in the case, when the assisting ion beam is applied in depositing the oriented layer 22, and Ar⁺ ions collide a deposition surface, the surface of the bed layer 21 is crystallized.

That is, in the embodiment, since the surface of the bed layer 21 is amorphous in depositing the oriented layer 22, the orientation degree of the oriented layer 22 which is formed on the bed layer 21 becomes high. Accordingly, the electrical conductivity of the superconducting wire 1 can be improved.

Furthermore, since the bed layer 21 is constituted of nesosilicate which has high oxygen permeability, oxygen passes through the bed layer 21 and easily reaches the metal substrate 10. Consequently, when the thickness of the bed layer 21, the thickness of the substrate surface layer 11 to be formed, the temperature of the heat treatment, and the like are the same, the treating time of the heat treatment can be shortened (the wire traveling speed can be faster) as compared with the case of the bed layer 21 constituted of GZO. Accordingly, the productivity increases, and the manufacturing costs of the superconducting wire 1 decrease.

Furthermore, because the bed layer 21 undergoes a transition to an amorphous phase in depositing the oriented layer 22, crystallization of the bed layer 21 by the heat treatment by which the substrate surface layer 11 is formed is not a problem. Consequently, the temperature of the heat treatment can be made higher. Accordingly, the treating time of the heat treatment can be further shortened.

### Example

In an example, the bed layers 21 constituted of ZrSiO₄, which is nesosilicate, were deposited in such a way as to have thicknesses of 8 nm, 10 nm, 50 nm, 100 nm, 200 nm, 300 nm, 500 nm, and 600 nm, respectively, on the tape-shaped Hastelloy substrates 10, respectively. After the bed layers 21 were deposited, the heat treatment was carried out at 500° C. for half an hour so as to form the substrate surface layers 11, respectively. The thicknesses of the formed substrate surface layers 11 were 400 nm, 300 nm, 120 nm, 80 nm, 50 nm, 30 nm, 10 nm, and 5 nm, respectively.

Then, the oriented layers (IBAD-MgO layers) 22 constituted of MgO were deposited in such a way as to have a thickness of 5 nm on the bed layers 21, respectively. On the oriented layers 22, the cap layers 23 constituted of CeO₂ were deposited in such a way as to have a thickness of 200 nm, respectively. On each of the bases 2 obtained thereby, the superconducting layer 30 and the stabilizing layer 40 were deposited, and hence the superconducting wires 1 were manufactured.

In the case of the bed layer 21 having a thickness of 10 nm to 500 nm, no matter which thickness the bed layer 21 had, the detachment of the intermediate layer 20 was not observed in depositing the superconducting layer 30. Furthermore, the diffusion of cations from the Hastelloy substrate 10 into the superconducting layer 30 was examined byAuger analysis of the superconducting layer 30 and the intermediate layer 20. As a result, Ni and Cr, which are representatives of cations, were not detected.

Furthermore, with regard to each of the obtained superconducting wires 1, the critical current in liquid nitrogen was measured by a four-probe method with the criterion of 1 μV/cm. As a result, a value of the critical current was 200 A or more. That is, excellent Ic characteristics were obtained.

In the case of the bed layer 21 having a thickness of 8 nm, the detachment of the intermediate layer 20 was not observed in depositing the superconducting layer 30. However, Ni and Cr in minute quantities were detected from the cap layer 23 by the Auger analysis. In addition, a value of the critical current of the obtained superconducting wire 1 was 140 A.

The reason is considered that, in the case of the bed layer 21 having a thickness of 8 nm, the thickness of the bed layer 21 was so thin that the applied Ar⁺ ions passed through the bed layer 21 or scratched the bed layer 21, and consequently, the metal substrate 10 situated under the bed layer 21 was exposed, and the function of the bed layer 21 to facilitate the orientation of the oriented-layer 22 was impaired.

In the case of the bed layer 21 having a thickness of 600 nm, the detachment of the intermediate layer 20 was observed in depositing the superconducting layer 30, and Ni and Cr in minute quantities were detected from the superconducting layer 30 by the Auger analysis. In addition, a value of the critical current of the obtained superconducting wire 1 was 150 A.

It is considered that, in the case of the bed layer 21 having a thickness of 600 nm, the thickness of the bed layer 21 was so thick that it was hard for oxygen to pass through the bed layer 21, the amount of oxygen supplied to the metal substrate 10 decreased, and the substrate surface layer 11 was not formed sufficiently, and as a result, the intermediate layer 20 partly detached. That is, when the bed layer 21 is too thick, the depositing time of the bed layer 21 itself increases (the wire traveling speed in the deposition becomes slower), and the treating time of the heat treatment by which the substrate surface layer 11 is formed also increases, and consequently, the productivity decreases, and the manufacturing costs increase. In addition, as the bed layer 21 is thickened, the superconducting wire 1 may be bent with the accumulation of strain therein.

It has been confirmed by the example that, by making the thickness of the bed layer 21 be 10 nm to 500 nm, the productivity does not decrease, and the bed layer 21 effectively functions. In particular, it is preferable to make the thickness of the bed layer 21 about 50 nm. In this case, the bed layer 21 functions as a bed layer for sure in depositing the oriented layer 22, and also the substrate surface layer 11 sufficient to prevent the detachment of the intermediate layer 20 can be efficiently formed because oxygen is sufficiently supplied to the metal substrate 10.

In the above, the embodiment of the present invention made by the present inventor is described in detail. However, the present invention is not limited to the above embodiment, and can be appropriately modified without departing from the scope of the present invention.

For example, in the base 2, the cap layer 23 may be constituted of any one of CeO₂, YSZ, LaMnO₃ (LMO), and SrTiO₃ (STO), or a combination of any two thereof. Furthermore, the base 2 may have a structure which does not include the cap layer 23.

Furthermore, the oriented layer 22 may be constituted of a monolayer of IBAD-MgO, or a composite layer in which self-oriented Epi-MgO epitaxially grown by PLD or the like is formed on IBAD-MgO.

Major laminated structures of the base 2 including the bed layer 21 constituted of ZrSiO₄ which is nesosilicate are shown in TABLE 1. When attention is paid to the characteristics of the base 2 and the number of deposition processes, the laminated structure in the “1” row in TABLE 1 is the best, the laminated structure (the laminated structure described in the embodiment) which is the simplest structure among the structures including the cap layer 23.

### [Table 1]

Furthermore, although not shown in TABLE 1, as nesosilicate constituting the bed layer 21, HfSiO₄, ThSiO₄, and USiO₄ may be used apart from ZrSiO₄. The oriented layer 22 may be constituted of any of GZO, CeO₂, YSZ, and NbO apart from MgO. As the metal substrate 10, a non-oriented metal substrate such as a SUS304 (stainless steel 340) substrate may be used apart from the Hastelloy substrate.

A first aspect of the embodiment of the present invention is a base for a superconducting wire, the base including: a metal substrate; a bed layer constituted of nesosilicate and formed on the metal substrate; and an oriented layer formed on the bed layer.

Preferably, the bed layer is formed by ion beam assisted deposition, and a surface of the bed layer is amorphous in forming the oriented layer.

Preferably, a substrate surface layer constituted of an oxide of a constituent element of the metal substrate is formed on an interface between the metal substrate and the bed layer by predetermined heat treatment after the bed layer is formed.

Preferably, a thickness of the bed layer is 10 nm to 500 nm.

Preferably, the bed layer is constituted of ZrSiO₄, HfSiO₄, ThSiO₄, or USiO₄.

Preferably, the oriented layer is constituted of MgO, GZO, CeO₂, YSZ, or NbO.

Preferably, the base further includes a cap layer formed on the oriented layer.

Preferably, the cap layer is constituted of CeO₂, YSZ, LaMnO₃, or SrTiO₃.

A second aspect of the embodiment of the present invention is a superconducting wire including: the base; and a superconducting layer formed on a surface of the base.

According to the embodiment of the present invention, since the surface of nesosilicate is amorphous in depositing the oriented layer 22, the orientation degree of the oriented layer 22 formed on the bed layer 21 constituted of nesosilicate becomes high. Accordingly, the electrical conductivity of the superconducting wire 1 can be improved.

The embodiment disclosed herein is an instance in every respect, and hence should not be regarded as a limit. The scope of the present invention is shown not by the above description but by the following scope of claims. It is intended that the present invention covers all the modifications of this invention provided they fall within the scope of the following claims and their equivalents.

The entire disclosure of Japanese Patent Application No. 2010-117077 filed on May 21, 2010 including the description, claims, drawings, and abstract is incorporated herein by reference in its entirety.

TABLE 1

| | | BIAXIALLY | BED | METAL |
|---|---|---|---|---|
| | CAP LAYER | ORIENTED LAYER | LAYER | SUBSTRATE |
| 1 | CeO₂ | IBAD-MgO | ZrSiO₄ | HASTELLOY |
| 2 | CeO₂ | Epi-MgO/IBAD-MgO | ZrSiO₄ | HASTELLOY |
| 3 | CeO₂/LMO | IBAD-MgO | ZrSiO₄ | HASTELLOY |
| 4 | CeO₂/LMO | Epi-MgO/IBAD-MgO | ZrSiO₄ | HASTELLOY |
| 5 | LMO | Epi-MgO/IBAD-MgO | ZrSiO₄ | HASTELLOY |
| 6 | STO | Epi-MgO/IBAD-MgO | ZrSiO₄ | HASTELLOY |
| 7 | — | Epi-MgO/IBAD-MgO | ZrSiO₄ | HASTELLOY |
| 8 | LMO | IBAD-MgO | ZrSiO₄ | HASTELLOY |
| 9 | STO | IBAD-MgO | ZrSiO₄ | HASTELLOY |
| 10 | — | IBAD-MgO | ZrSiO₄ | HASTELLOY |

What is claimed is:

1. A base for a superconducting wire, the base comprising:
a metal substrate;
a bed layer constituted of nesosilicate and formed on the metal substrate; and
an oriented layer formed on the bed layer.

2. The base according to claim 1, wherein the bed layer is formed by ion beam assisted deposition, and a surface of the bed layer is amorphous in forming the oriented layer.

3. The base according to claim 1, wherein a substrate surface layer constituted of an oxide of a constituent element of the metal substrate is formed on an interface between the metal substrate and the bed layer by predetermined heat treatment after the bed layer is formed.

4. The base according to claim 1, wherein a thickness of the bed layer is 10 nm to 500 nm.

5. The base according to claim 1, wherein the bed layer is constituted of ZrSiO₄, HfSiO₄, ThSiO₄, or USiO₄.

6. The base according to claim 1, wherein the oriented layer is constituted of MgO, GZO, CeO₂, YSZ, or NbO.

7. The base according to claim 1 further comprising a cap layer formed on the oriented layer.

8. The base according to claim 7, wherein the cap layer is constituted of CeO₂, YSZ, LaMnO₃, or SrTiO₃.

9. A superconducting wire comprising:
the base according to claim 1; and
a superconducting layer formed on a surface of the base.
